(19) United States
(12) Patent Application Publication
(10) Pub. No.: US 2013/0054719 A1
(43) Pub. Date: Feb. 28, 2013

(54) MEDIA FILE PLAYING APPARATUS AND MEDIA FILE PROVIDING APPARATUS, AND METHODS THEREOF

(71) Applicants: Ji-ho CHU, Suwon-si (KR); Young-joon AHN, Yongin-si (KR)

(72) Inventors: Ji-ho CHU, Suwon-si (KR); Young-joon AHN, Yongin-si (KR)

(73) Assignee: SAMSUNG ELECTRONICS CO., LTD., Suwon-si (KR)

(21) Appl. No.: 13/594,052

(22) Filed: Aug. 24, 2012

(30) Foreign Application Priority Data
Aug. 29, 2011 (KR) 10-2011-0086507

(51) Int. Cl. G06F 15/16

(52) U.S. Cl. 709/206

(57) ABSTRACT

A media file playing apparatus and a media file providing apparatus are provided. The media file playing apparatus includes: a communication unit which communicates with at least one media file providing apparatus which provides a media file; a media file player which plays the media file; and a controller which receives a request to play the media file from the media file providing apparatus, transmits control information about the playing of the media file to the media file providing apparatus, receives the media file and a control signal from the media file providing apparatus, and controls the media file player to play the media file in accordance with the received control signal.

### CROSS-REFERENCE TO RELATED APPLICATION

This application claims priority from Korean Patent Application No. 10-2011-0086507, filed on Aug. 29, 2011 in the Korean Intellectual Property Office, the disclosure of which is incorporated herein by reference.

### BACKGROUND

1. Field

Apparatuses and methods consistent with the exemplary embodiments relate to a media file playing apparatus and a media file providing apparatus, and control methods thereof, and more particularly, to a media file playing apparatus for playing a media file, a media file providing apparatus for providing the media file to the media file playing apparatus, and control methods thereof.

2. Description of the Related Art

A television (TV), an audio system, a personal computer (PC), a game console, and a media file playing apparatus play a media file of contents such as an image, a moving picture, music, etc. The media file playing apparatus may play a media file generated or stored therein, or may receive a media file from a separate media file providing apparatus and play it.

The media file providing apparatus may include various apparatuses that can store a media file and transmit it to the media file playing apparatus. For example, a cellular phone, a smart phone, an MP3 player, a camera, and the mobile terminal may be involved in the media file providing apparatus.

When the media file providing apparatus provides a media file to the media file playing apparatus, the media file providing apparatus may serve as a server for effectively transmitting the files. That is, the media file providing apparatus determines whether the media file playing apparatus that serves as a client requests a media file, and transmits the requested media file to the media file playing apparatus.

However, if the media file providing apparatus serves as the server for providing the media file, the media file providing apparatus may be burdened with excessive operational load and power consumption because the media file providing apparatus has to continuously monitor the client for requests for media files and execute corresponding actions based on the requests. In the case of the mobile terminal or similar apparatus susceptible to the operational load, the power consumption, etc., such burdens may cause bigger problems.

### SUMMARY

Accordingly, one or more exemplary embodiments provide a media file playing apparatus and a media file providing apparatus, and control methods thereof, in which a burden associated with operational load and power consumption can be minimized.

Another exemplary embodiment provides a media file playing apparatus and a media file providing apparatus, and control methods thereof, which are more convenient for a user to play a media file while minimizing a burden with operational load and power consumption.

The foregoing and/or other aspects may be achieved by providing a media file playing apparatus including: a communication unit which communicates with at least one media file providing apparatus providing a media file; a media file player which plays the media file; and a controller which receives a request to play the media file from the media file providing apparatus, transmits control information about the playing of the media file to the media file providing apparatus, receives the media file and a control signal from the media file providing apparatus, and controls the media file player to play the media file in accordance with the received control signal.

The controller may include a web server that operates regarding the media file providing apparatus as a client.

The control information about the playing of the media file may include information about a function supportable by the media file player with regard to the playing of the media file.

The controller may transmit playing state information of the media file to the media file providing apparatus.

The media file playing apparatus may further include: a signal receiver which receives a broadcasting signal, and a signal processor which processes the broadcasting signal.

The media file playing apparatus may further include a display unit which displays an image based on the broadcasting signal processed by the signal processor.

Another aspect of the exemplary embodiments may be achieved by providing a method of controlling a media file playing apparatus, the method including: receiving a request for playing a media file from at least one media file providing apparatus providing the media file; transmitting control information about the playing of the media file to the media file providing apparatus; receiving the media file and a control signal from the media file providing apparatus; and playing the media file in accordance with the received control signal

The receiving the request for playing the media file may include the media file playing apparatus operating as a web server by considering the media file providing apparatus to be a client.

The control information about the playing of the media file may include information about a function supportable by the media file player with regard to the playing of the media file.

The method may further include transmitting playing state information of the media file to the media file providing apparatus.

The method may further include: receiving a broadcasting signal; and processing the broadcasting signal.

The method may further include displaying an image based on the broadcasting signal.

Still another aspect of the exemplary embodiments may be achieved by providing a media file providing apparatus including: a communication unit which communicates with a media file playing apparatus which plays a media file; a storage unit which stores the media file; a user input unit which receives a user's command; and a controller which requests the media file playing apparatus to play the media file, receives control information about the playing of the media file from the media file playing apparatus, and transmits the media file and a control signal based on the user's command to the media file playing apparatus so that the media file can be played based on the received control information.

The controller of the media file providing apparatus may include a web browser that operates by considering the media file playing apparatus to be a web server.

The control information about the playing of the media file may include information about a function supportable by the media file playing apparatus with regard to the playing of the media file.

The media file providing apparatus may further include a display unit, wherein the controller displays the control information regarding the playing of the media file on the display unit.

The controller may receive playing state information of the media file from the media file playing apparatus, and display the received playing state information on the display unit.

Yet another aspect of the exemplary embodiments may be achieved by providing a method of controlling a media file providing apparatus storing a media file, the method including: requesting a media file playing apparatus which plays the media file to play the media file; receiving control information regarding the playing of the media file from the media file playing apparatus; receiving a user's command regarding the playing of the media file; and transmitting the media file and a control signal based on the user's command to the media file playing apparatus so that the media file can be played based on the control information.

The requesting the playing of the media file may include a web browser of the media file playing apparatus operating as a web server.

The control information regarding the playing of the media file may include information about a function supportable by the media file playing apparatus with regard to the playing of the media file.

The method may further include displaying the control information regarding the playing of the media file on a display unit.

The method may further include receiving playing state information of the media file from the media file playing apparatus; and displaying the received playing state information on a display unit.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 shows a media file playing apparatus and a media file providing apparatus according to an exemplary embodiment;

FIG. 2 is a block diagram showing a configuration of the media file playing apparatus shown in FIG. 1;

FIG. 3 is a flowchart showing an example of operations of the media file playing apparatus shown in FIGS. 1 and 2;

FIG. 4 is a block diagram showing a configuration of the media file providing apparatus shown in FIG. 1;

FIG. 5 is a flowchart showing an example of operations of the media file providing apparatus shown in FIGS. 1 and 4;

FIG. 6 is a flowchart showing another example of operations of the media file playing apparatus shown in FIGS. 1 and 2; and

FIG. 7 is a flowchart showing another example of operations of the media file providing apparatus shown in FIGS. 1 and 4.

### DETAILED DESCRIPTION OF EXEMPLARY EMBODIMENTS

Below, the exemplary embodiments will be described.

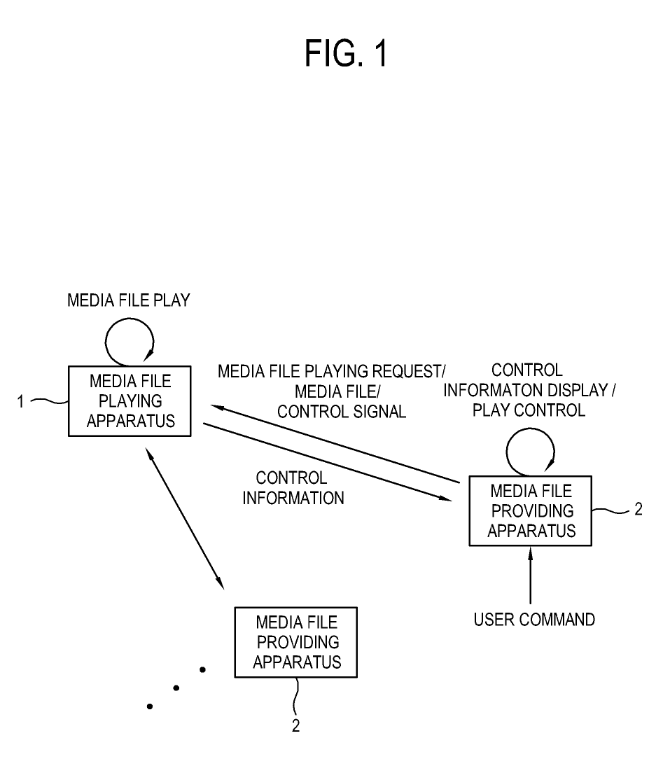

FIG. 1 shows a media file playing apparatus and a media file providing apparatus according to an exemplary embodiment. The media file playing apparatus 1 may be an apparatus such as a television (TV), an audio system, a personal computer (PC), a game console, or the like, but is not limited thereto, and has a function of playing a media file such as an image, a moving picture, music, or similar contents. The media file providing apparatus 2 may be a cellular phone, a smart phone, an MP3 player, a camera, or the like, but is not limited thereto, and transmits the media file to be played in the media file playing apparatus 1 to the media file playing apparatus 1.

The media file playing apparatus 1 and the media file providing apparatus 2 are connected to each other for playing of the media file. The media file providing apparatus 2 is not limited to a single apparatus. Alternatively, a plurality of media file providing apparatuses 2 may be connected to the media file playing apparatus 1.

The media file providing apparatus 2 requests the media file playing apparatus 1 to play a media file in accordance with a user's command. In response to the request, the media file playing apparatus 1 transmits control information for controlling the media file to the media file providing apparatus 2. The media file providing apparatus 2 can display the received control information, and transmit a control signal and a media file to be played in the media file playing apparatus in accordance with a user's command, to the media file playing apparatus 1. The media file playing apparatus 1 plays the media file in accordance with the received control signal.

Accordingly, in the media file playing apparatus 1 and the media file providing apparatus 2 according to an exemplary embodiment, operations that are normally performed by a server for playing a media file, i.e., the operations of monitoring a media file playing request from a client and operating in accordance with the results of the monitoring, are performed in the media file playing apparatus 1. This results in reduced operational loads or power consumption. Therefore, the media file can be played with minimum operational load or power consumption.

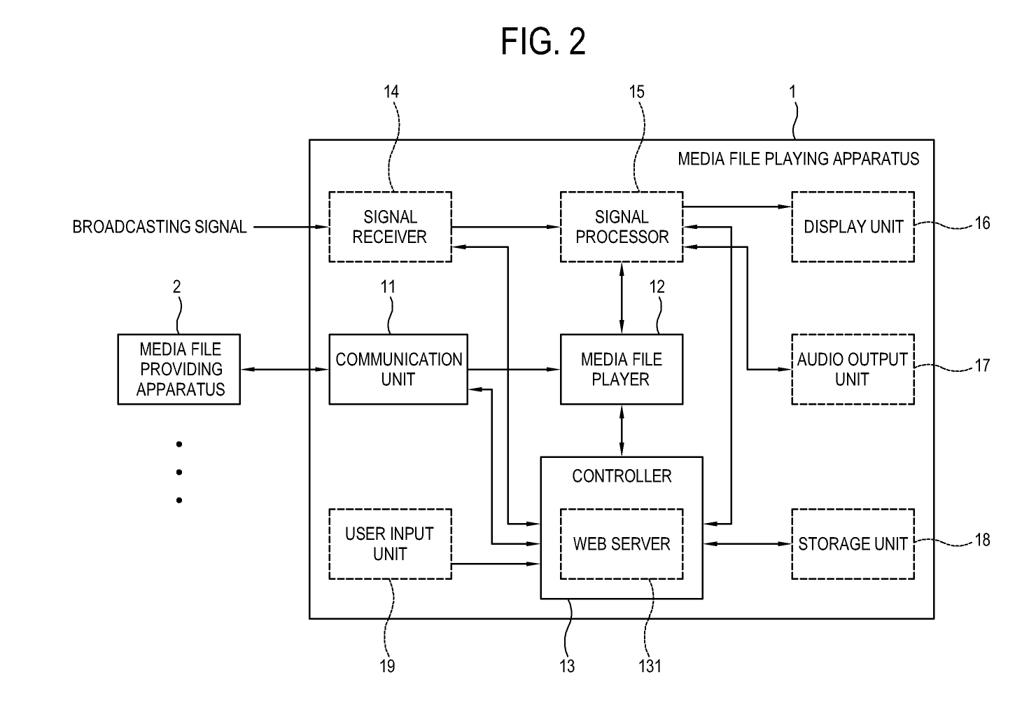

FIG. 2 is a block diagram showing a configuration of the media file playing apparatus shown in FIG. 1. As shown in FIG. 1, the media file playing apparatus 1 may include a communication unit 11, a media file player 12, and a controller 13. The communication unit 11 performs communication with the media file providing apparatus 2 so as to play a media file. There is no limit to a communication method between the communication unit 11 and the media file providing apparatus 2. For example, the communication method may include a local area network (LAN), Wi-Fi, etc.

The media file player 12 plays a media file received through the communication unit 11. There is no limit to the type of contents of the media file played by the media file player 12. The media file may contain contents such as an image, video, audio, etc., but is not limited thereto. Additionally, there is no limit to a format of a media file, and the media file may have all of various known formats.

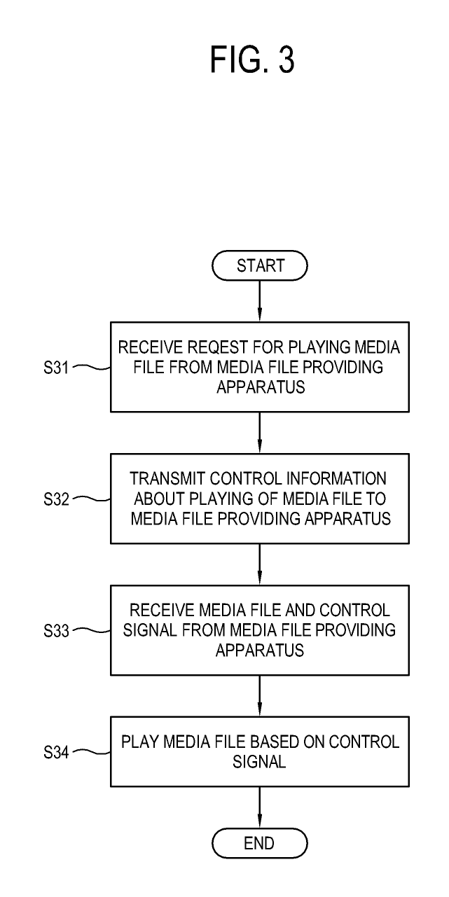

The controller 13 performs control for playing the media file. FIG. 3 is a flowchart showing an example of operations of the media file playing apparatus 1. The operations shown in FIG. 3 may be controlled by the controller 13. Referring to FIG. 3, at operation S31, the controller 13 receives a request for playing a media file from the media file providing apparatus. At operation S32, the controller 13 transmits control information about playing of the media file to the media file providing apparatus 2 through the communication unit. The control information about the playing of the media file includes information about a function supportable by the media file player 12 with regard to the playing of the media file. The information about the function supportable by the media file player 12 may, for example include information about a file format playable by the media file player 12, information about playing control functions such as fast forward (FF), rewind (REW), pause (PAUSE), etc. supportable by the media file player 12, information about optional functions such as playing time display, etc.

Referring back to FIG. 3, at operation S33, the controller 13 receives a media file to be played, and a control signal for playing the media file in accordance with a user's command, from the media file providing apparatus 2 through the communication unit 11. For example, the control signal may include a play command, a fast forward command, a rewind command, etc. for the media file. Then, at operation S34, the controller 13 controls the media file player 12 to play the received media file in accordance with the received control signal.

Although not shown, the controller 13, according to an exemplary embodiment, may include a control program for carrying out the foregoing operations, a non-volatile memory in which the control program is stored, a volatile memory into which at least some of the control program stored in the non-volatile memory is loaded, and a microprocessor for executing the control program loaded into the volatile memory. Meanwhile, the media file player 12 may include a control program, a non-volatile memory, a volatile memory and a microprocessor similar to the controller 13. Also, the media file player 12 and the controller 13 may be integrated with each other.

Referring back to FIG. 2, the media file playing apparatus 1 may further include at least one of a signal receiver 14 for receiving a broadcasting signal such as a TV signal; a signal processor 15 for processing the broadcasting signal received by the signal receiver 14; a display unit 16 for displaying an image based on the broadcasting signal processed by the signal processor 16; an audio output unit 17 for outputting sound based on the broadcasting signal processed by the signal processor 16; a storage unit 18 of a non-volatile memory for storing data such as an image, sound and other information of the broadcasting signal; and a user input unit 19 for receiving a user's command.

The signal processor 15 may process a video signal and/or an audio signal output by a playing operation of the media file player 12, and the processed video and audio signals may be output as an image and/or sound through the display unit 16 and/or the audio output unit 17, respectively.

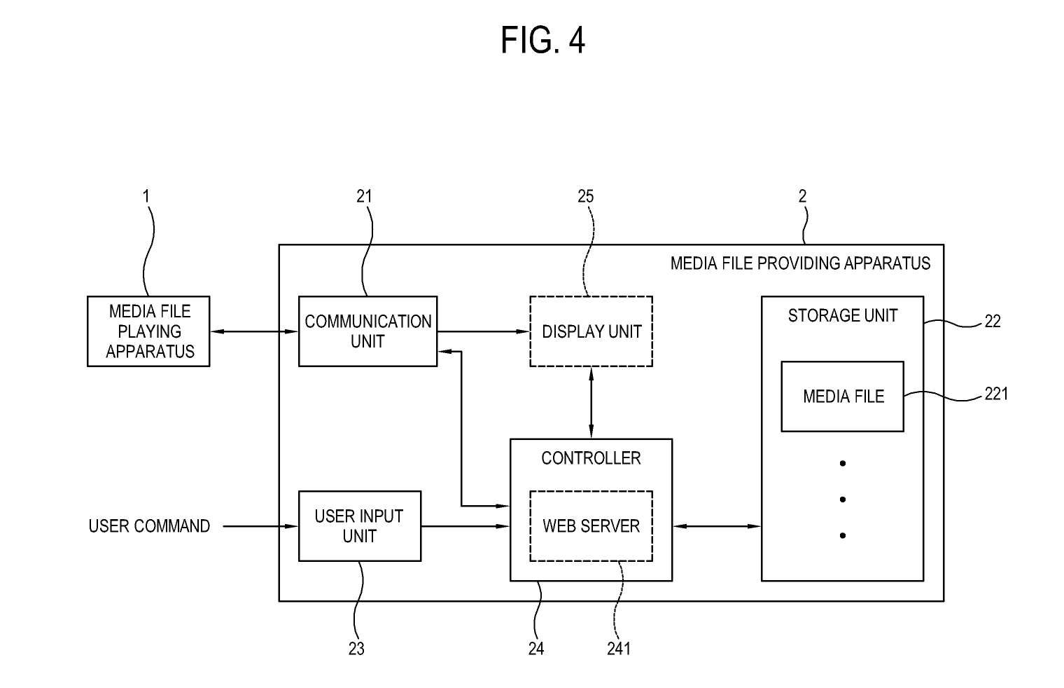

FIG. 4 is a block diagram showing a configuration of the media file providing apparatus 2 shown in FIG. 1. As shown in FIG. 4, the media file providing apparatus 2 may include a communication unit 21, a storage unit 22, a user input unit 23 and a controller 24.

The communication unit 21 performs communication with the communication unit 11 of the media file playing apparatus 1 in order to play a media file.

The storage unit 22 may be a non-volatile memory, which stores a media file to be provided to the media file playing apparatus 1. The media file is not limited to one, and a plurality of media files may be stored in the storage unit 22. The user input unit 23 receives a user's command regarding the playing of the media file.

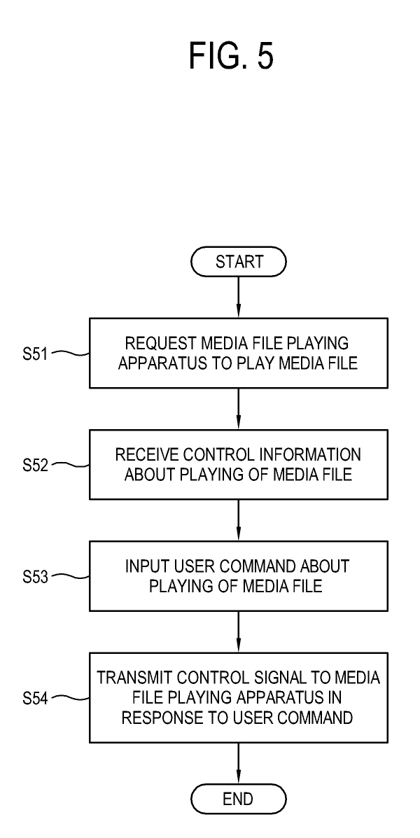

The controller 24 performs control for playing the media file. FIG. 5 is a flowchart showing an example of operations of the media file providing apparatus 2. The operations shown in FIG. 5 may be controlled by the controller 24. Referring to FIG. 5, at operation S51, the controller 24 requests the media file playing apparatus 1 to play a media file, through the communication unit 21. The controller 24 may request the media file playing apparatus 1 to play the media file in accordance with a user's command from the user input unit 23.

At operation S52, the controller 24 receives control information about the playing of the media file from the media file playing apparatus 1 through the communication unit 21. Next, at operation S53, the controller 24 receives a user's command regarding the playing of the media file, through the user input unit 23. The user's command regarding the playing of the media file may, for example, include a play command, a fast forward command, a rewind command, etc. for the media file. Then, at operation S54, the controller 24 transmits a media file to be played and a control signal corresponding to the user's command input to the media file playing apparatus 1 through the communication unit 21.

Although not shown, the controller 24 according to an exemplary embodiment may include a control program for carrying out the foregoing operations, a non-volatile memory in which the control program is stored, a volatile memory into which at least some of the control program stored in the non-volatile memory is loaded, and a microprocessor for executing the control program loaded into the volatile memory.

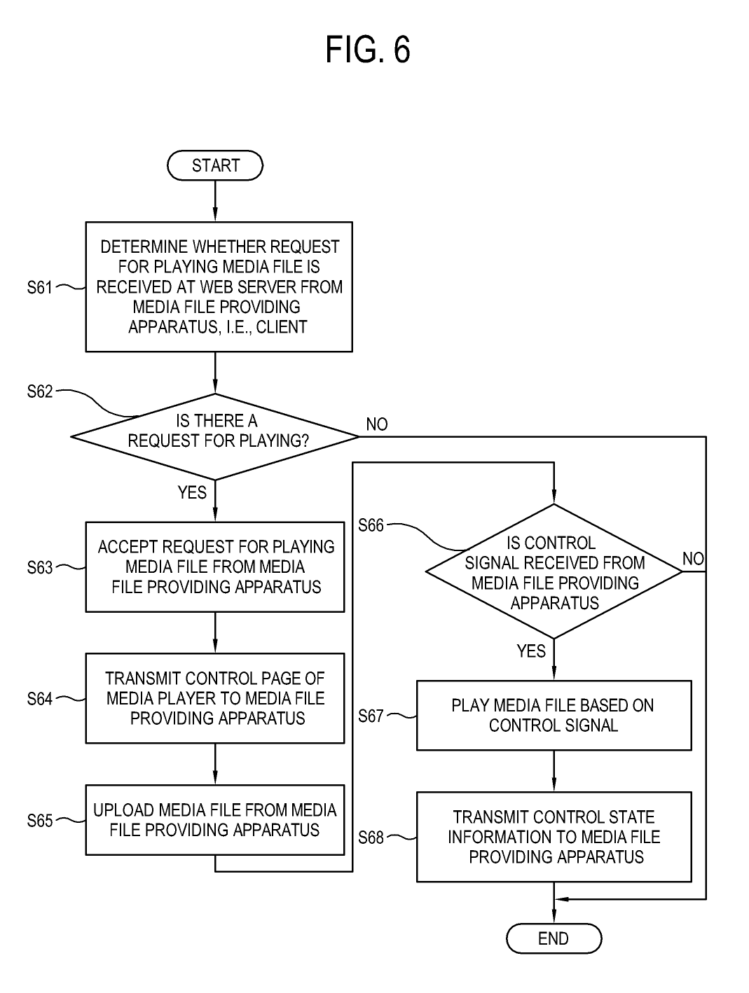

FIG. 6 is a flowchart showing another example of operations of the media file playing apparatus 1 shown in FIG. 2. The operations of the media file playing apparatus 1 shown in FIG. 6 may be controlled by the controller 13. In this exemplary embodiment, the controller 13 of the media file playing apparatus 1 may include a web server 131 that operates as a server and the media file providing apparatus 2 may operate as a client as shown in FIG. 2.

First, at operation S61, the media file playing apparatus 1 which acts as a web server, determines whether a request for playing the media file is received from the media file providing apparatus 2 which acts as a client. If it is determined at operation S62 that the request for playing the media file is received from the media file providing apparatus 2, the media file playing apparatus 1 at operation S63 accepts the request for playing the media file from the media file providing apparatus 2. Then, at operation S64, the media file playing apparatus 1 transmits a control page of the media file player for playing the media file to the media file providing apparatus 2. The control page of the media file player may be a web page which contains the control information of the media file player 12 as described above. Then, at operation S65, the media file playing apparatus 1 uploads the media file to be played from the media file providing apparatus 2. At operation S66, the media file playing apparatus 1 determines whether the control signal regarding the playing of the media file is received from the media file providing apparatus 2. As a result of the determination, if the control signal regarding the playing of the media file is received from the media file providing apparatus 2, the media file playing apparatus 1 at operation S67 plays the uploaded media file in accordance with the received control signal. At operation S68, the media file playing apparatus 1 transmits control state information of the media file being played to the media file providing apparatus 2. For example, the control state information of the media file may include information regarding the state of play of the media file, for example, play/fast forward/rewind/pause of the media file; information about a current playing point of time in relation to the full playing time of the media file; etc.

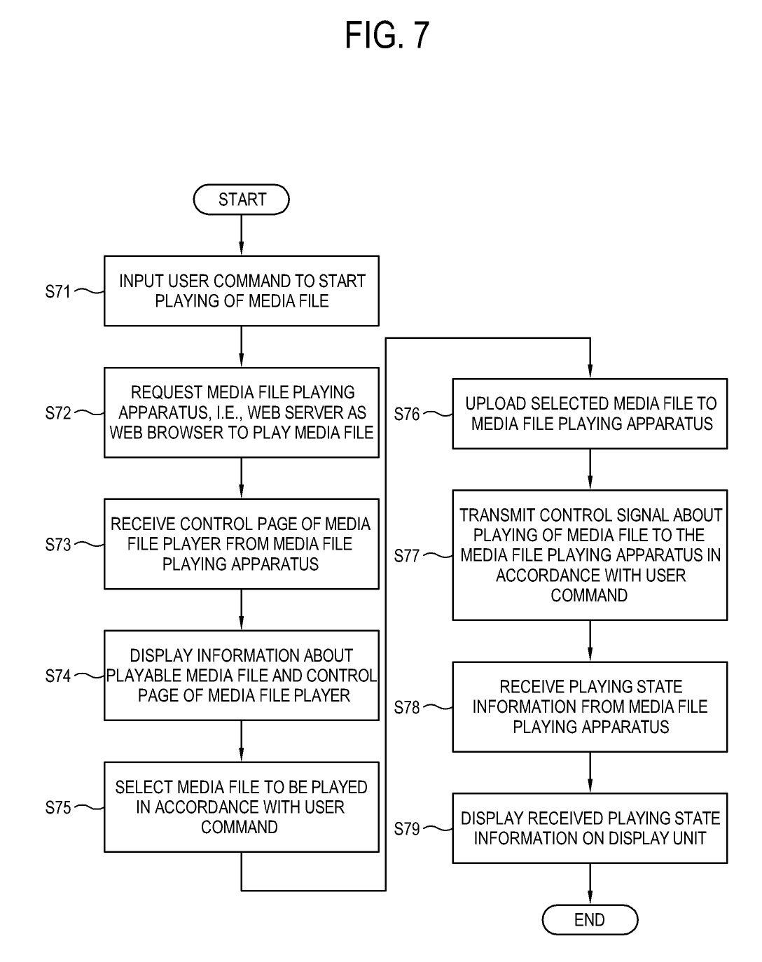

FIG. 7 is a flowchart showing another example of operations of the media file providing apparatus 2 shown in FIG. 4. The operations of the media file providing apparatus 2 shown in FIG. 7 may be controlled by the controller 24. In this exemplary embodiment, the controller 24 of the media file providing apparatus 2 may include a web browser 241 that operates as a client, and the web server 131 of the media file playing apparatus 1 may operate as the server.

First, at operation S71, the media file providing apparatus 2 receives a user's command to start playing a media file. Then, at operation S72, the media file providing apparatus 2 requests the web server 131 of the media file playing apparatus 1 to play the media file in accordance with operations of the web browser 241. At operation S73, the media file providing apparatus 2 receives from the media file playing apparatus 1, a control page of the media file player to play the media file. At operation S74, the media file providing apparatus 2 displays the control page of the media file player and information of the playable media file. As shown in FIG. 4, the media file providing apparatus 2 may further include a display unit 25 which displays the control page of the media file player and the information about the playable media file.

Referring back to FIG. 7, at operation S75, the media file providing apparatus 2 selects the media file to be played in accordance with a user's command through the control page of the media file player. At operation S76, the media file providing apparatus 2 uploads the selected media file to the web server 131 of the media file playing apparatus 1 in accordance with operations of the web browser 241. Next, at operation S77, the media file providing apparatus 2 transmits a control signal about the playing of the media file to the media file playing apparatus 1 in accordance with a user's command. In the operation S77, the media file providing apparatus 2 may use a predetermined graphic user interface (GUI, not shown) displayed on the control page of the media file player in order to receive a user's command about the playing of the media file. At operation S78, the media file providing apparatus 2 may receive playing state information of the media file from the media file playing apparatus 1 during the playing of the media file. At operation S79, the media file providing apparatus 2 may display the playing state information of the media file on the display unit 25.

Accordingly, it is more convenient for a user to play the media file since the user can check the playing information transmitted from the media file playing apparatus 1 through the media file providing apparatus 2 during a playing operation of the media file.

As described above, there are provided a media file playing apparatus and a media file providing apparatus, and control methods thereof, in which a burden with operational load and power consumption can be minimized.

Further, there are provided a media file playing apparatus and a media file providing apparatus, and control methods thereof, which are more convenient for a user to play a media file while minimizing a burden with operational load and power consumption.

Although a few exemplary embodiments have been shown and described, it will be appreciated by those skilled in the art that changes may be made in these exemplary embodiments without departing from the principles and spirit of the application, the scope of which is defined in the appended claims and their equivalents.

What is claimed is:

1. A media file playing apparatus comprising:
a communication unit which communicates with at least one media file providing apparatus which provides a media file;
a media file player which plays the media file; and
a controller which receives a request for playing the media file from the media file providing apparatus, transmits control information regarding the playing of the media file to the media file providing apparatus, receives the media file and a control signal from the media file providing apparatus, and controls the media file player to play the media file in accordance with the received control signal.

2. The media file playing apparatus according to claim 1, wherein the controller comprises a web server that operates by considering the media file providing apparatus to be a client.

3. The media file playing apparatus according to claim 1, wherein the control information regarding the playing of the media file comprises information about a function supported by the media file player with regard to the playing of the media file.

4. The media file playing apparatus according to claim 1, wherein the controller transmits playing state information of the media file to the media file providing apparatus.

5. The media file playing apparatus according to claim 1, further comprising:
a signal receiver which receives a broadcasting signal; and
a signal processor which processes the broadcasting signal.

6. The media file playing apparatus according to claim 5, further comprising a display unit which displays an image based on the broadcasting signal processed by the signal processor.

7. A method of controlling a media file playing apparatus, the method comprising:
receiving a request for playing a media file from at least one media file providing apparatus which provides the media file;
transmitting control information regarding the playing of the media file to the media file providing apparatus;
receiving the media file and a control signal from the media file providing apparatus; and
playing the media file in accordance with the received control signal.

8. The method according to claim 7, wherein the receiving the request for playing the media file comprises operating the media file playing apparatus as a web server and operating the media file providing apparatus as a client.

9. The method according to claim 7, wherein the control information regarding the playing of the media file comprises information about a function supported by the media file player with regard to the playing of the media file.

10. The method according to claim 7, further comprising transmitting playing state information of the media file to the media file providing apparatus.

11. The method according to claim 7, further comprising:
receiving a broadcasting signal; and
processing the broadcasting signal.

12. The method according to claim 11, further comprising displaying an image based on the broadcasting signal.

13. A media file providing apparatus comprising:
a communication unit which communicates with a media file playing apparatus which plays a media file;
a storage unit which stores the media file;
a user input unit which receives a user's command; and
a controller which requests the media file playing apparatus to play the media file, receives control information regarding the playing of the media file from the media file playing apparatus, and transmits the media file and a control signal based on the user's command to the media file playing apparatus so that the media file can be played based on the received control information.

14. The media file providing apparatus according to claim 13, wherein the controller comprises a web browser that operates by considering the media file playing apparatus to be a web server.

15. The media file providing apparatus according to claim 13, wherein the control information regarding the playing of the media file comprises information about a function supported by the media file playing apparatus with regard to the playing of the media file.

16. The media file providing apparatus according to claim 13, further comprising a display unit, wherein
the controller displays the control information regarding the playing of the media file on the display unit.

17. The media file providing apparatus according to claim 16, wherein the controller receives playing state information of the media file from the media file playing apparatus, and displays the received playing state information on the display unit.

18. A method of controlling a media file providing apparatus which stores a media file, the method comprising:
requesting a media file playing apparatus to play the media file;
receiving control information regarding the playing of the media file from the media file playing apparatus;
receiving a user's command regarding the playing of the media file; and
transmitting the media file and a control signal based on the user's command to the media file playing apparatus so that the media file can be played based on the control information.

19. The method according to claim 18, wherein the requesting the playing of the media file comprises operating the media file providing apparatus as a web browser by considering the media file playing apparatus to be a web server.

20. The method according to claim 18, wherein the control information about the playing of the media file comprises information about a function supported by the media file playing apparatus with regard to the playing of the media file.

21. The method according to claim 18, further comprising displaying the control information regarding the playing of the media file on a display unit.

22. The method according to claim 18, further comprising receiving playing state information of the media file from the media file playing apparatus; and
displaying the received playing state information on a display unit.

23. A method of playing a media file by a media file playing apparatus, the method comprising:
transmitting, by a media file providing apparatus, a request to the media file playing apparatus to play the media file;
transmitting control information for playing the media file to the media file providing apparatus;
receiving, by the media file playing apparatus, a control signal and the media file from the media file providing apparatus, and
playing the media file by the media file playing apparatus.

24. The method of claim 23, wherein the media file playing apparatus transmits a control page of a media file player to the media file providing apparatus.

25. The method of claim 24, wherein the control page is a web page which contains the control information of the media file player.
